(19) United States
(12) Patent Application Publication
(10) Pub. No.: US 2024/0126874 A1
(43) Pub. Date: Apr. 18, 2024

(54) SECURITY PROCESSING DEVICE, METHOD AND ELECTRONIC DEVICE FOR HANDLING ATTACKS

(71) Applicant: NUVOTON TECHNOLOGY CORPORATION, HSINCHU CITY (TW)

(72) Inventor: YEN-JU CHEN, HSINCHU CITY (TW)

(21) Appl. No.: 18/326,583

(22) Filed: May 31, 2023

(30) Foreign Application Priority Data
Oct. 18, 2022 (TW) 111139344

(51) Int. Cl. G06F 21/55; G06F 21/54; G06F 21/57

(52) U.S. Cl. CPC G06F 21/554; G06F 21/54; G06F 21/575

(57) ABSTRACT

A security processing device for handling attacks including an attack detector, a programing time controller, a non-volatile memory device and a processing unit. The attack detector is used to detect whether an attack event occurs, and generate an attack trigger signal when the attack event occurs. The programing time controller is electrically connected to the attack detector, and used to update a first flag value when receiving the attack trigger signal. The non-volatile memory device is electrically connected to the program time controller, and used to store the first and the second flag values. The processing unit is electrically connected to the program time controller. When the security processing device is reset or boot-up, the programing time controller updates the second flag value and adjusts a time of a first instruction processed through the processing unit based on the first flag value and the second flag value.

### CROSS-REFERENCE TO RELATED APPLICATION

This application claims the priority from the TW Patent Application No. 111139344, filed on Oct. 18, 2022, and all contents of such TW Patent Application are included in the present disclosure.

### BACKGROUND

### 1. Field of the Invention

The present disclosure is related to the security processing technology for avoiding side-channel attack or fault injection for obtaining confidential data (such as keys), in particular to, a technical solution of a security processing device, a method and an electronic device for handling attacks, and wherein when the device is boot-up or reset the technical solution detects flag values to determine whether the device is attacked before boot-up or reset, and adjusts the time for a processing unit to process the instruction accordingly.

### 2. Description of the Related Art

By fault injection, hackers skip certain execution programs to analyze the information obtained many times to get the confidential information inside the chip. In order to prevent such incidents from happening, the relevant firmware and hardware countermeasures are developed. When the chip detects an attack event occurs, the conventional manner is to make the hardware reset the system or clear the key. For the former, the system is repeatedly reset when the system continues to be attacked, it makes the system unable to continue to perform normally. For the latter, even the internal confidential information does not leak, clearing the key will cause the subsequent execution of the system to no longer be protected by the key. Thus, clearing the key is not a perfect countermeasure. Simply speaking, there is a need in the industry for how to prevent hacker attacks from happening without disturbing with system operation.

### SUMMARY

It can be understood from the above description that the technical problems to be solved via the present disclosure is how to prevent the occurrence of hacker attacks from disturbing the system operation without clearing the key when the chip is attacked by fault injection. Further, in the present disclosure, the method mainly adopted is to flexibly adjust the time for a processing unit to process an instruction, that is, adjust an instruction cycle to prevent keys from being obtained by hackers via analysis. Also, the chip is secured to operate in a safe state without clearing the key.

To solve the above conventional problems, embodiments of the present disclosure provide a security processing device for handling attacks. The security processing device includes an attack detector, a programing time controller, a non-volatile memory device and a processing unit. The attack detector is used to detect whether an attack event occurs. The attack detector generates an attack trigger signal when an occurrence of the attack event is detected. The programing time controller is electrically connected to the attack detector, and used to update the first flag value when the attack trigger signal is received. The non-volatile memory device is electrically connected to the programing time controller, and used to store the first flag value and the second flag value. The processing unit is electrically connected to the programing time controller. When the security processing device is reset or boot-up, the programing time controller updates the second flag value, and adjusts a time for the processing unit to process the first instruction based on the first flag value and the second flag value.

To solve the above conventional problems, embodiments of the present disclosure further provide an electronic device. The electronic device includes the preceding security processing device and a functional circuit. The functional circuit is electrically connected to the security processing device.

To solve the above conventional problems, embodiments of the present disclosure further provide a security processing method for handling attacks. The security processing method is implemented with the security processing device, and the steps are described as follows. In the attack event detection step, the attack detector detects whether an attack event occurs. In the flag value updated step, the first flag value is updated when detecting the attack event occurs. In the flag value comparison step, the first flag value and the second flag value are compared when the security processing device is reset or boot-up. In the processing step, when the first flag value does not match the second flag value, the programing time controller updates the second flag value and adjusts the time for processing unit to process the first instruction processed.

To sum up, the security processing device, the method and the electronic device provided by the present disclosure can effectively prevent confidential data from being obtained by hackers via attacks. As well, the key will not be deleted during attack, so that there are no technical problems about interfering with the system operation.

### BRIEF DESCRIPTION OF THE DRAWINGS

The drawings are provided to make the persons with ordinary knowledge in the field of the art further understand the present disclosure, and are incorporated into and constitute a part of the specification of the present disclosure. The drawings illustrate demonstrated embodiments of the present disclosure, and are used to explain the principal of the present disclosure together with the description of the present disclosure.

FIG. 1 is a block diagram of a security processing device for handling attacks according to an embodiment of the present disclosure;

FIG. 2 is a block diagram of a security processing device for handling attacks according to another embodiment of the present disclosure;

FIG. 3 is a block diagram of an electronic device according to an embodiment of the present disclosure; and

FIG. 4 is a flowchart of a security processing method for handling an attack according to an embodiment of the present disclosure.

### DESCRIPTION OF THE PREFERRED EMBODIMENTS

The present disclosure is implemented in any chip with an attack detector, that is, a security processing device can be implemented in a chip form. Based on the judge of a proposed programing time controller, the processing instruction cycle of the processing unit, that is, the time for a processing unit to process an instruction is adjusted, so that the program executes each access stage at a non-fixed time point. In this way, it is difficult for an attacker to find an attack point, so as to achieve the purpose of protecting the chip from side-channel attacks. When an attack detector detects that an attack event occurs, the attack detector transmits an attack trigger signal to a programing time controller. After receiving the attack trigger signal, the programing time controller performs an inversion operation the first flag value, that is, the flag value which is used to record the current attack status to record the occurrence of a new attack event, such as changing the first flag value from 0 to 1 or from 1 to 0.

Whenever boot-up or system reset happens, the programing time controller confirms whether the first flag value is as same as the second flag value, that is, a flag value which is used to record the previous attack status before shutdown or reset. When the first flag value and the second flag value are the same, it means that the chip does not detect the attack event before boot-up or reset happens. Therefore, the processing unit is not allowed to adjust the instruction cycle. When the first flag value and the second flag value are not the same, it means that the attack event is detected by the chip before boot-up or system reset happens. Therefore, the programing time controller updates the second flag value into the first flag value, that is, the programing time controller makes the second flag value be equal to the first flag value. Also, the instruction cycle of the processing unit is adjusted, that is, the time for the processing unit to process the instruction is adjusted.

Both the first flag value and the second flag value may be stored by a non-volatile memory device, such as a flash memory device. The first flag value is used to record the status value of detecting the attack event whenever the chip is running. The second flag value is a reference value of the chip in the safe state when boot-up or system reset happens. Moreover, the first flag value is as the same as the initial value of the second flag value. The first flag value used to record the state value of the attack event is not limited to perform the inversion operation, that is, changing from 0 to 1 or changing from 1 to 0, and the first flag value may also be a count accumulated value or a count diminution value. In conclusion, the first flag value is used as one of the parameters when the programing time controller adjusts the instruction cycle.

Further, the implementation manners of adjusting the time for the processing unit to process the instruction are as follows. A specific delayed time is added in the fetch instruction stage, that is, a fetch time of the fetch instruction is delayed by the specific time. Besides, the specific time may be irregularly changed based on a random number generated by a random number generator. Alternatively, a meaningless pseudo instruction is added to the original instruction. For example, zero is added to the additional operation, zero is added to the subtraction operation, multiplying by one is added to the multiplication operation, dividing by one is added to the division operation, or a specific number is added to the additional operation and the specific number is added to the subtraction operation, etc. Alternatively, the original instruction is changed into several meaningful instructions, for example, adding five in the additional operation is changed into adding 3 and adding 2 in the additional operation. By the way, the implementation manners of changing the original instruction into several meaningful instructions or adding a meaningless pseudo instruction to the original instruction belong to the implementation manners of expanding the original instruction into a plurality of instructions.

In a specific embodiment, the action of adjusting the instruction cycle is not necessary to be performed for each instruction when boot-up or reset happens. However, the action of adjusting the instruction cycle can only be performed for a specific instruction and a specific access address corresponding to an attack event, and the details are described below. The attack trigger signal is not only transmitted to the programing time controller, but also transmitted to the processing unit when the attack event occurs. Then, the processing unit transmits the current attack information to the programing time controller when the processing unit receives the attack trigger signal. Besides, the attack information comprises the specific instruction being executed and the specific access address of the memory device corresponding to the specific instruction. In this way, during reset or boot-up, the processing unit only performs the action of adjusting the instruction cycle for the specific instruction and the specific access address corresponding to the attack event.

For example, when the attack event occurs, the specific instruction executed is MOV, that is, a moving data instruction, and the specific access address is 0x20003000, etc. During reset or boot-up, when the first flag value is detected to be different from the second flag value, the instruction is MOV instruction and the specific access address is 0x20003000, the processing unit delays the fetch time of the MOV instruction by a specific time. That is, the time that the MOV instruction moves the data to 0x20003000 is delayed by the specific time.

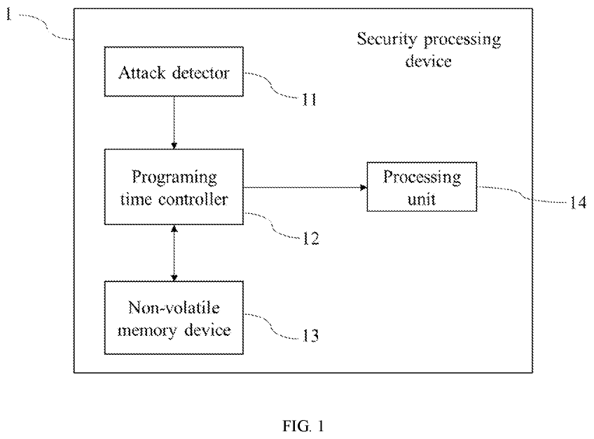

After describing the main innovation essence and concepts of the present disclosure, embodiments of the security processing device of the present disclosure are further described. Firstly, refer to FIG. 1, FIG. 1 is a block diagram of a security processing device for handling attacks according to an embodiment of the present disclosure. A security processing device 1 for handling attacks comprises an attack detector 11, a programing time controller 12, a non-volatile memory device 13 and a processing unit 14. The programing time controller 12 is electrically connected to the attack detector 11. The non-volatile memory device 13 is electrically connected to the programing time controller 12. The processing unit 14 is electrically connected to the programing time controller 12. The security processing device 1 may be implemented in a form of a chip, and the security processing device 1 may be a microcontroller unit, but the present disclosure is not limited thereto.

The attack detector 11 is used to detect whether an attack event occurs. As well, the attack detector 11 generates an attack trigger signal when an occurrence of the attack event is detected. The programing time controller 12 is used to update the first flag value when the attack trigger signal is received. The non-volatile memory device 13 is used to store the firs flag value and the second flag value. When the security processing device 1 is reset or boot-up, it is determined whether the first flag value matches the second flag value. When the security is reset or boot-up, if it is determined that the first flag value is not match the second flag value, the programing time controller 12 updates the second flag value and adjust the time for the processing unit 14 to process the instruction, that is, the instruction cycle of the instruction executed by the processing unit 14 is adjusted. Moreover, the manner that the programing time controller 12 updates the second flag value is to make the second flag value be equal to the first flag value.

Furthermore, the manner of updating the first flag value via the programing time controller 12 may be inverting the first flag value, that is, changing from 0 to 1 or changing from 1 to 0, increasing by a specific value, that is, using an increment counter, or decreasing by a specific value, that is, using a count-down counter. Whether the first flag value matches the second flag value refers to whether the first flag value is equal to the second flag value when the first flag value is updated by using the inversion operation, or refers to whether a difference value between the first flag value and the second flag value is less than a difference threshold value when the first flag value is updated by using the increment counter or the counter-down counter.

In addition, the manner of above-mentioned adjusting the time for the processing unit 14 to process the instruction, that is, adjusting the instruction cycle of the instruction executed by the processing unit 14 may be to make the programing time controller 12 instruct the processing unit 14 to expand the instruction to be processed into several instructions, so as to adjust the time for the processing unit 14 to process the original instruction accordingly. Besides, the several expanded instructions include the original instruction and at least one meaningless pseudo instruction. Alternatively, the several expanded instructions are several meaningful instructions which are generated by disassembling the original instruction. For example, an instruction for multiplying 3 by 7 may be disassembled into an instruction for three temporary values which the initial value is 0 adding 7.

In another embodiment, the manner of above-mentioned adjusting the time for the processing unit 14 to process the instruction, that is, adjusting the instruction cycle of the instruction executed by the processing unit 14 may be make the programing time controller 12 instruct the processing unit 14 to delay the fetch time of the fetch instruction by a specific time. Besides, the delay time is determined by a random number. Further, the processing unit 14 comprises two stages when the instruction is processed, and the two stages are fetching the instruction and executing the fetched instruction. Thus, by delaying the fetch time of the fetch instruction by the specific time, the time for the processing unit 14 to process the instruction is changed, that is, the instruction cycle of the instruction executed by the processing unit 14 is adjusted.

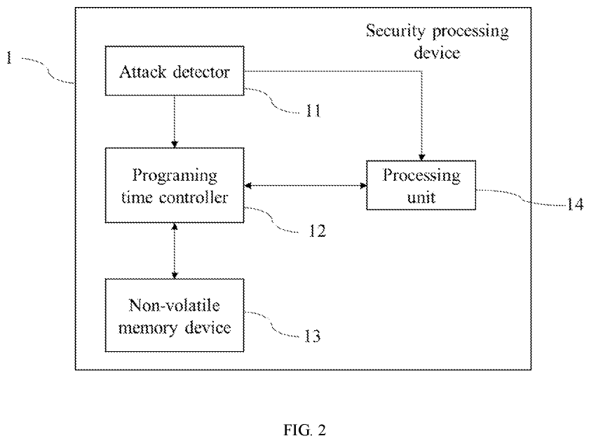

In order to prevent the processing unit 14 from adjusting the time of each instruction when boot-up or reset happens, an embodiment may be further designed so that only when the instruction is a specific instruction corresponding to the attack event and the access address of the external memory device corresponding to the instruction is a specific access address, the instruction cycle of the instruction is adjusted. Refer to FIG. 2, FIG. 2 is a block diagram of a security processing device for handling attacks according to another embodiment of the present disclosure. It is different from FIG. 1, in FIG. 2, the attack detector 11 is further electrically connected to the processing unit 14. Thus, the attack detector 11 further transmits the attack trigger signal to the processing unit 14 when the attack detector 11 detects the occurrence of the attack event. Then, the processing unit 14 transmits the attack information to the programing time controller 12 after the processing unit 14 receives the attack trigger signal. The attack information includes the information of the specific instruction and the specific access address corresponding to the attack event. As well, when the first flag value does not match the second flag value during boot-up or reset, it is only allowed that the programing time controller 12 adjusts the time for the processing unit 14 to process the instruction when the instruction is the specific instruction and the access address is the specific access address corresponding to the instruction. For other instructions, or the instruction is the specific instruction but the access address is not the specific access address, the time for the processing unit 14 to process these instructions is not adjusted.

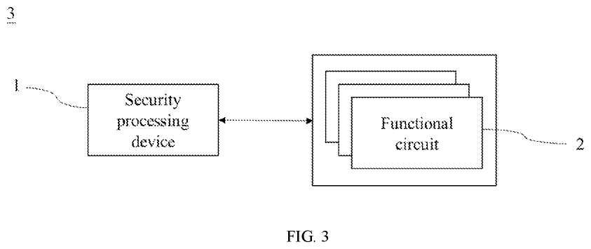

Next, refer to FIG. 3, FIG. 3 is a block diagram of an electronic device according to an embodiment of the present disclosure. An electronic device 3 comprises the security processing device 1 and a functional circuit 2. The security processing device 1 is electrically connected to the functional circuit 2, so that the security processing device 1 can use the functional circuit 2. For example, the functional circuit 2 may be a memory device, a storage device, a computing device, or a circuit capable of implementing other functions, and the present disclosure is not limited thereto.

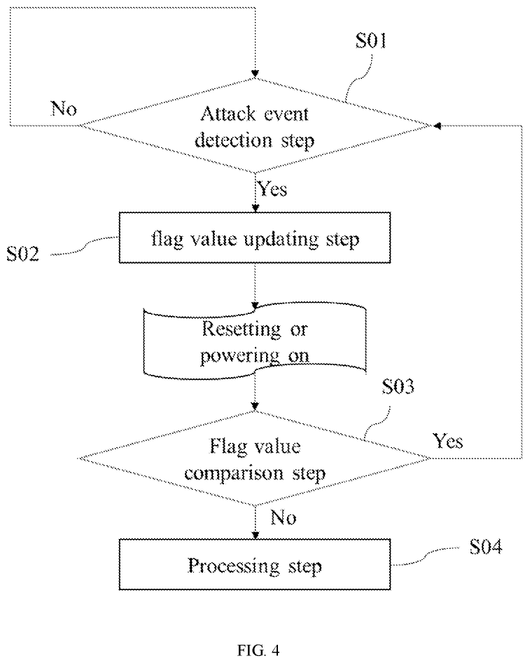

Next, refer to FIG. 1 and FIG. 4, FIG. 4 is a flowchart of a security processing method for handling an attack according to an embodiment of the present disclosure. A security processing method is executed with the security processing device 1, and the security processing method comprises an attack event detection step S01, a flag value updating step S02, a flag value comparison step S03 and a processing step S04. In the attack event detecting step S01, it is detected whether an attack event occurs. When the attack event is detected, the step S02 is executed. Otherwise, the step S01 is executed continuously. In the flag value updating step S02, the first value is updated when the attack event is detected. Next, when the security processing device 1 is reset or boot-up, and the flag value comparison step S03 is proceeding, the first flag value is compared with the second flag value. Moreover, the first flag value is used to record the status value of detecting attack events whenever the chip is running, and the second flag value is a reference value of the chip security status when boot-up or the system reset happens. In the flag value comparison step S03, when the first flag value and the second flag value match each other, step S01 is proceeded. Otherwise, the processing step S04 is proceeded. In the processing step S04, the second flag value is updated, and the time for the processing unit 14 to process the instruction in the security processing device 1 is adjusted, that is, the instruction cycle is adjusted. In addition, the manners of adjusting the time for the processing unit 14 to process the instruction in the security processing device 1 are as described above, so it is not repeated here.

Refer to FIG. 2 and FIG. 4, similarly, the security processing method may also be designed that only when the instruction is the specific instruction corresponding to the attack event and when the access address of the external memory device corresponding to the instruction is a specific access address, the instruction cycle of the instruction is adjusted. Therefore, in the flag value updating step S02, the attack information is also transmitted to the processing unit 14. The attack information comprises the information of the specific instruction and the specific access address corresponding to the attack event. As well, in the processing step S04, when the instruction is the specific instruction and the access address is the specific access address corresponding to the instruction, the time for the processing unit 14 to process the instruction is allowed to be adjusted, that is, the instruction cycle is adjusted.

As stated as above, when a fault injection attack occurs, compared to the related art that the key is cleared directly, the security processing device, the method and the electronic device provided by the embodiments of the present invention flexibly adjust the instruction cycle for the processing unit, that is, the processed time of the instruction to prevent keys from being obtained by hackers via analysis. Further, the security processing device can be protected to operate in the safe state without clearing the key. Furthermore, when the attack event is detected, compared to the related art that the system is reset continuously, the security processing device of the present invention can flexibly adjust the instruction cycle of the processing unit when boot-up or reset happens. As a result, it can avoid the occurrence of hacker attacks without disturbing the system operation, and the security processing device does not need to be reset continuously.

It should be understood that the examples and the embodiments described herein are for illustrative purpose only, and various modifications or changes in view of them will be suggested to those skilled in the art, and will be included in the spirit and scope of the application and the appendix with the scope of the claims.

What is claimed is:

1. A security processing device for handling attacks, comprising:
an attack detector, configured to detect whether an attack event occurs, and generate an attack trigger signal when an occurrence of the attack event is detected;
a programing time controller, electrically connected to the attack detector, and configured to update a first flag value when the attack trigger signal is received;
a non-volatile memory device, electrically connected to the programing time controller, and configured to store the first flag value and a second flag value; and
a processing unit, electrically connected to the programing time controller, wherein when the security processing device is reset or boot-up, the programing time controller updates the second flag value and adjusts a time for the processing unit to process a first instruction or any one instruction based on the first flag value and the second flag value.

2. The security processing device according to claim 1, wherein the security processing device updates the first flag value via inverting the first flag value, increasing the first flag value by a specific value or decreasing the first flag value by the specific value.

3. The security processing device according to claim 1, wherein when the security processing device is reset or boot-up, and when the first flag value and the second flag value are different from each other, the programing time controller utilizes the first flag value to update the second flag value.

4. The security processing device according to claim 1, wherein the programing time controller instructs the processing unit to expand the first instruction into a plurality of second instructions to adjust the time for the processing unit to process the first instruction.

5. The security processing device according to claim 4, wherein the plurality of the second instructions include the first instruction and a pseudo instruction, or
the plurality of the second instructions are a plurality of instructions generated by disassembling the first instruction.

6. The security processing device according to claim 1, wherein the programing time controller instructs the processing unit to delay a fetch time of the first instruction by a specific time to adjust the time for the processing unit to process the first instruction.

7. The security processing device according to claim 6, wherein the specific time is determined by a random number.

8. The security processing device according to claim 1, wherein the attack detector is further electrically connected to the processing unit,
wherein the attack trigger signal is generated when the attack detector detects the occurrence of the attack event,
wherein after the processing unit receives the attack trigger signal, an attack information of the attack event is transmitted to the programing time controller, wherein the attack information includes an information of a specific instruction and a specific access address corresponding to the attack event, and
wherein when the any one instruction is the specific instruction, and an access address is the specific access address corresponding to the any one instruction, the programing time controller is allowed to adjust the time for the processing unit to process the any one instruction.

9. An electronic device, comprising:
a security processing device for handling attacks, including:
an attack detector, configured to detect whether an attack event occurs, and generate an attack trigger signal when an occurrence of the attack event is detected;
a programing time controller, electrically connected to the attack detector, and configured to update a first flag value when the attack trigger signal is received;
a non-volatile memory device, electrically connected to the programing time controller, and configured to store the first flag value and a second flag value; and
a processing unit, electrically connected to the programing time controller, wherein when the security processing device is reset or boot-up, the programing time controller updates the second flag value and adjusts a time for the processing unit to process a first instruction or any one instruction processed based on the first flag value and the second flag value; and
a functional circuit, electrically connected to the security processing device.

10. The electronic device according to claim 9, wherein the security processing device updates the first flag value via inverting the first flag value, increasing the first flag value by a specific value or decreasing the first flag value by the specific value.

11. The electronic device according to claim 9, wherein when of the security processing device is reset or boot-up, and when the first flag value and the second flag value are different from each other, the programing time controller utilizes the first flag value to update the second flag value.

12. The electronic device according to claim 9, wherein the programing time controller instructs the processing unit to expand the first instruction into a plurality of second instructions to adjust the time for the processing unit to process the first instruction processed.

13. The electronic device according to claim 12, wherein the plurality of the second instructions include the first instruction and a pseudo instruction, or
the plurality of the second instructions are a plurality of instructions generated by disassembling the first instruction.

14. The electronic device according to claim 9, wherein the programing time controller instructs the processing unit to delay a fetch time of the first instruction by a specific time to adjust the time for the processing unit to process the first instruction processed.

15. The electronic device according to claim 14, wherein the specific time is determined by a random number.

16. The electronic device according to claim 9, wherein the attack detector is further electrically connected to the processing unit,
wherein the attack trigger signal is generated when the attack detector detects the occurrence of the attack event,
wherein after the processing unit receives the attack trigger signal, an attack information of the attack event is transmitted to the programing time controller, wherein the attack information includes an information of a specific instruction and a specific access address corresponding to the attack event, and
wherein when the any instruction is the specific instruction, and an access address is the specific access address corresponding to the any one instruction, the programing time controller is allowed to adjust the time for the processing unit to process the any one instruction processed.

17. A security processing method for handling attacks, which is implemented with a security processing device, comprising:
an attack event detection step: an attack detector detecting whether an attack event occurs;
a flag value updating step: a programing time controller updating a first flag value when the attack event is detected;
a flag value comparison step: when the security processing device is reset or boot-up, the programing time controller comparing the first flag value and a second flag value; and
a processing step, when the first flag value does not match the second flag value, the programing time controller updating the second flag value and adjusting a time for the processing unit to process a first instruction or any one instruction.

18. The security processing method according to claim 17, wherein in the processing step, the programing time controller instructs the processing unit to expand the first instruction into a plurality of second instructions, or
the programing time controller instructs the processing unit to delay a fetch time of the first instruction by a specific time to adjust the time for the processing unit to process the first instruction.

19. The security processing method according to claim 17, wherein in the flag value updating step, the processing unit further transmits an attack information to the programing time controller, wherein the attack information includes an information of a specific instruction and a specific access address corresponding to the attack event, and
in the processing step, when the any one instruction is the specific instruction, and an access address of the any one instruction is the specific access address, the time for the processing unit to process the any one instruction is allowed to adjust.
